(19) United States
(12) Patent Application Publication
(10) Pub. No.: US 2008/0208458 A1
(43) Pub. Date: Aug. 28, 2008

(54) Multi-functional map displayer

(75) Inventor: Chia-Chun Wu, Jhonghe City (TW)

Correspondence Address: Troxell Law Office Pllc, Suite 1404, 5205 Leesburg Pike, Falls Church, VA, 22041, US

(73) Assignee: Archer Wireless Co., Ltd.

(21) Appl. No.: 11/709,886

(22) Filed: Feb. 23, 2007

(51) Int. Cl. G01C 21/36

(52) U.S. Cl. 701/208

(57) ABSTRACT

A multi-functional map displayer is composed of an input interface, a display interface, and a transmission interface, wherein a longitude and latitude of a desired location can be entered on the input interface, and a signal of the entered longitude and latitude can be transmitted to internet through the transmission interface, such that a map of that location can be downloaded from the internet to the display interface, for displaying the map and other map-related data, allowing a user to save a memory space used for storing the complete map, and cost spent in purchasing map software of each place, and achieving purposes of providing the user to check, navigate, and ensuring a safe trip.

### BACKGROUND OF THE INVENTION

(a) Field of the Invention

The present invention relates to a multi-functional map displayer, and more particularly to a multi-functional map displayer by which a longitude and latitude of a desired location are input and an area map of the desired longitude and latitude is downloaded from internet.

(b) Description of the Prior Art

Before using a conventional satellite navigation device, software of a complete map should be installed, and a desired location, address, or building is selected upon using the software. However, a fortune is spent to purchase the map software when installing it, and therefore, if an area to be navigated is different, then the map software for the desired location should be purchased continuously. In addition, the map software should occupy a certain amount of memory space in the satellite navigation device; for example, there are 51 states in the United States of America, and each state will require a memory space of 500 MB. Accordingly, if a user who needs to travel around each area is to use the satellite navigation device, the map software for many places should be installed, which will cause a burden on the money to be spent, and an increase in cost.

### SUMMARY OF THE INVENTION

The primary object of present invention is to provide a multi-functional map displayer, wherein a memory space to be used for storing a complete map, cost spent for purchasing map software of each place can be saved, and purposes of providing a user to check, navigate and ensuring a safe trip can be achieved, by entering a longitude and latitude of a desired location, and downloading from internet the area map of the desired longitude and latitude.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of the present invention.

FIG. 2 shows a flow diagram of the present invention.

FIG. 3 shows a schematic view of an embodiment of the present invention.

FIG. 4 shows a second schematic view of an embodiment of the present invention.

FIG. 5 shows a third schematic view of an embodiment of the present invention.

### DETAILED DESCRIPTION OF THE PREFERRED EMBODIMENTS

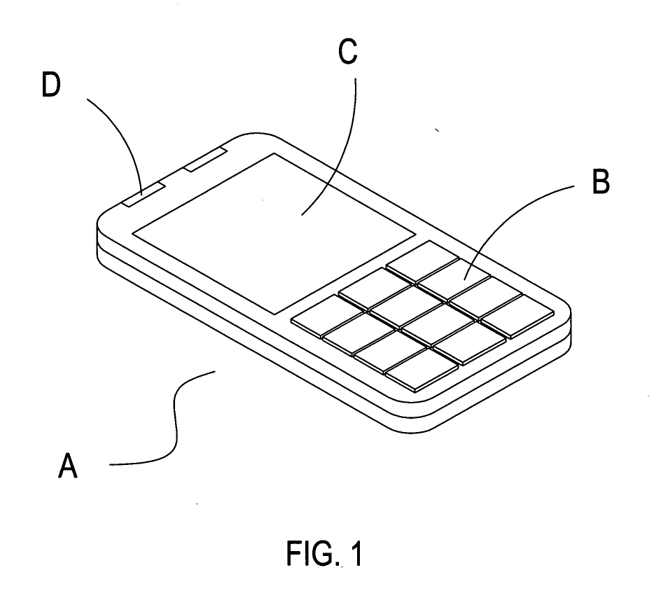

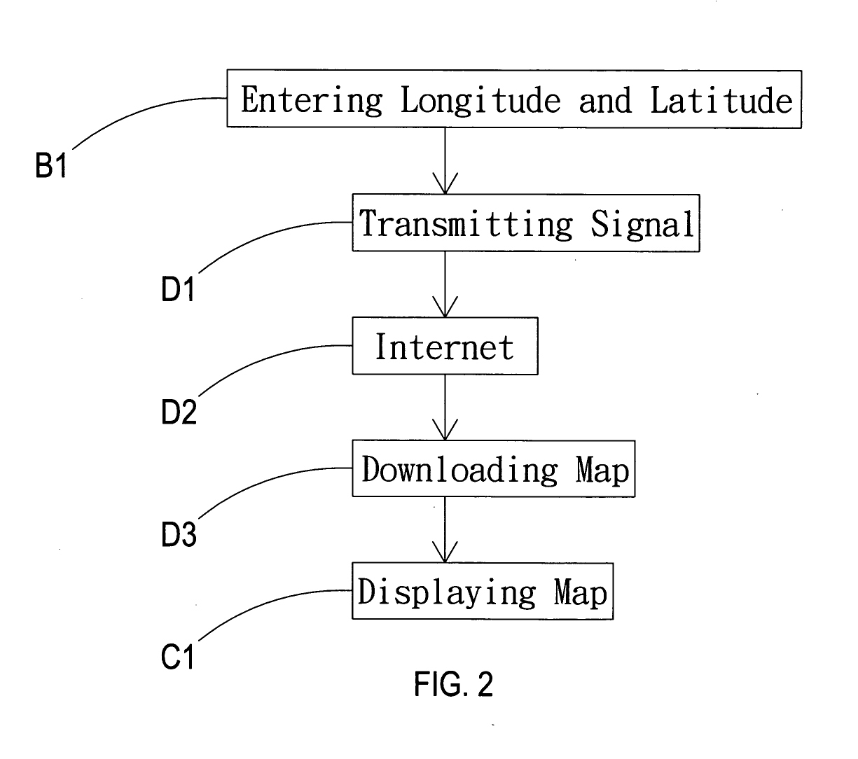

Referring to FIG. 1 and FIG. 2, the present invention is to provide a multi-functional map displayer A which comprises an input interface B, a display interface C, and a transmission interface D. A longitude and latitude of a desired area can be entered B1 through the input interface B, and a signal of the inputted longitude and latitude B1 is transmitted D1 to internet D2 through the transmission interface D, such that a map can be downloaded D3 from the internet D2, and be received by the display interface C for displaying the map C1 or other map-related data, allowing a user to be aware of the map of the desired area by inputting the longitude and latitude, to save a memory space used for storing the complete map, and cost spent for purchasing map software of each place, and to achieve purposes of providing the user to check, navigate, and ensure a safe trip.

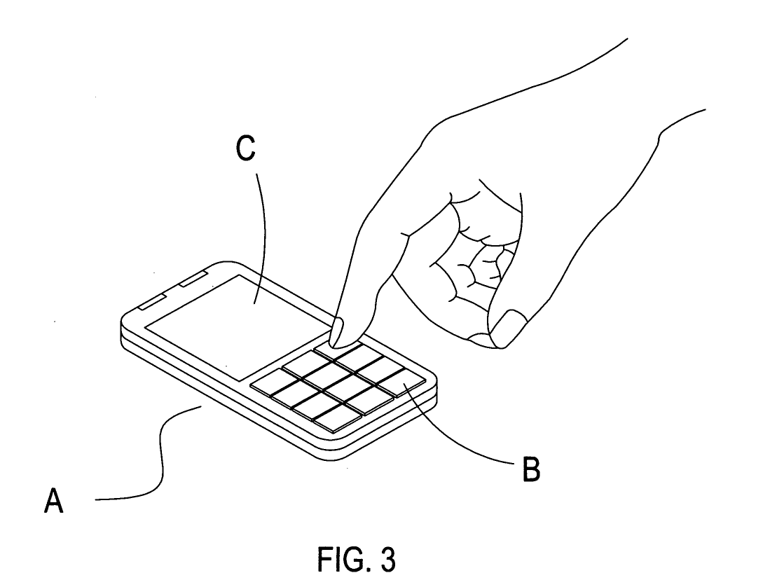

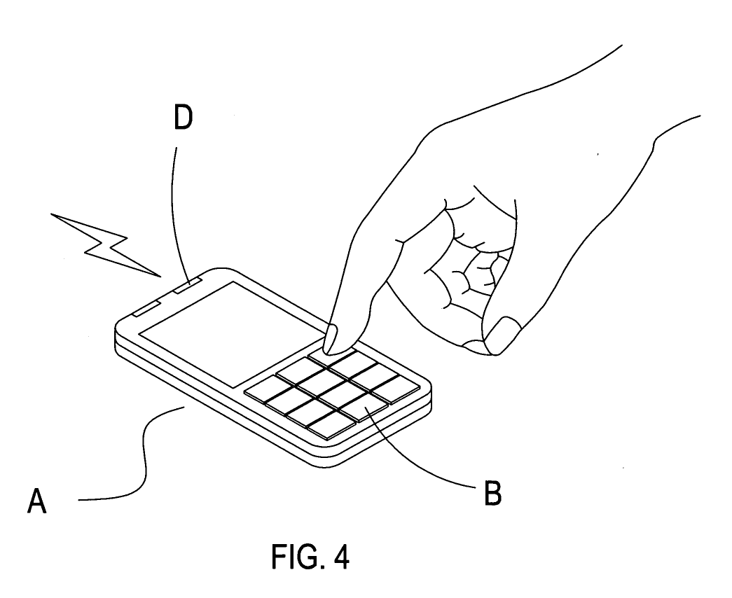

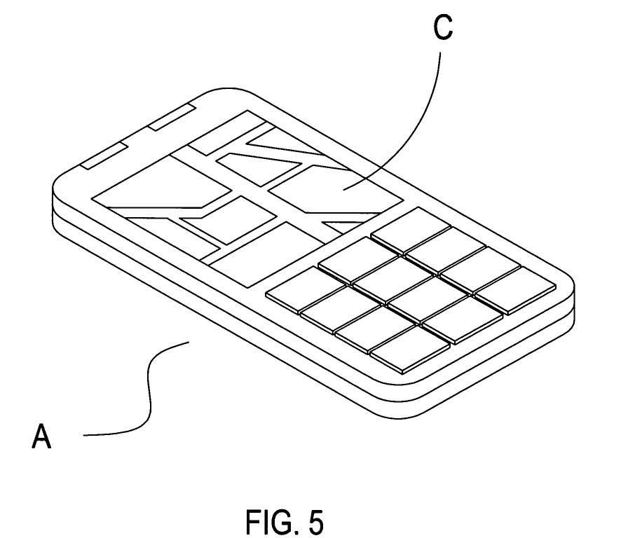

Referring to FIGS. 2 to 5, when the user needs to be aware of information of an area map by the map displayer A, he or she will enter the longitude and latitude B1 of the desired location on the input interface B, the signal of the entered longitude and latitude B1 will then be transmitted D1 to the internet D2 through the transmission interface D, such as a WI-FI (Wireless Fidelity), WIMAX (Worldwide Interoperability for Microwave Access), or GPRS (General Packet Radio Service). In addition, the longitude and latitude information can be acquired at a same time by a wireless transmission, such as the WI-FI, WIMAX, or GPRS, and the map of the entered longitude and latitude B1 can be searched for in the internet D2 and downloaded D3 from the internet D2. The downloaded map D3 can be received by the display interface C, such as an LCD (Liquid Crystal Display) or other displaying device, and the map or other map-related data are displayed C1 through the display interface C, allowing the user to check, navigate, and ensuring a safe trip. The map which is downloaded after entering the longitude and latitude B1 in the map displayer A, or the map information about the place where the user is located, can be transmitted through the transmission interface D to the user who needs to receive, so as to enable the user who needs to receive to know surrounding environment and map of a destination place, and to achieve a purpose of ensuring the safe trip. The map displayer A can be connected with a computer by a wired connection method, such as a PS/2, USB (Universal Serial Bus), IEEE-1394, and RS-232, such that the area map of desired longitude and latitude can be downloaded by the computer from the internet, and at a same time, the information about the downloaded map D3 by entering the longitude and latitude B1, can be shared among other hand-held devices by a wired or wireless method.

In order to further manifest advancement and practicability of the present invention, the advantages thereof are listed below:
1. Software of a complete map will not be installed before using the map displayer.
2. There is no need to purchase the map software.
3. It is not necessary to purchase the map software of a different local place.
4. There is no need to expand a memory space.
5. It can reduce a burden on money to be spent by a user.
6. It can lower cost.
7. It is provided with industrial competitiveness.
8. It is provided with value of business utilization.
9. It is provided with novelty.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A multi-functional map displayer comprising an input interface for entering a longitude and latitude of a desired location; a display device, which displays a state of use, and an area map of the desired location; and a transmission interface, which transmits the entered longitude and latitude to internet, such that the area map is downloaded from the internet and received by the display device; by entering the longitude and latitude of desired location, and by downloading the area map of the desired longitude and latitude from the internet, a user being aware of the map of desired area from the longitude and latitude, to save a memory space used for storing the complete map, and cost spent in purchasing map software of each place, and to achieve purposes of providing the user to check, navigate, and ensuring a safe trip.

2. The multi-functional map displayer according to claim 1, wherein the map displayer saves the longitudes and latitudes that have been used previously, allowing the user to re-use, thereby decreasing a trouble of acquiring the longitude and latitude once more.

3. The multi-functional map displayer according to claim 1, wherein the transmission interface is further a WI-FI (Wireless Fidelity), WIMAX (Worldwide Interoperability for Microwave Access), GPRS (General Packet Radio Service), or other related wireless transmission method which transmits signals to the internet.

4. The multi-functional map displayer according to claim 1, wherein the map displayer accesses the longitude and latitude of the desired area directly by a wireless transmission method, and the area map of desired longitude and latitude is then downloaded from the internet.

5. The multi-functional map displayer according to claim 1, wherein the map downloaded by entering the longitude and latitude, or map information about a place where the user is located, is transmitted to the user who needs to receive through the transmission interface, allowing the user who needs to receive to know surrounding environment and map about a destination place, and at a same, achieving a purpose of ensuring the safe trip.

6. The multi-functional map displayer according to claim 1, wherein the map displayer is connected to a computer by a wired method, such as a PS/2, USB (Universal Serial Bus), IEEE-1394, and RS-232, such that the area map of the desired longitude and latitude downloaded is downloaded from the internet by the computer.

7. The multi-functional map displayer according to claim 1, wherein the transmission interface uses a wired or wireless method to share the map or other map-related information which is downloaded by entering the longitude and latitude, among other hand-held devices.

8. The multi-functional map displayer according to claim 1, wherein the display interface is further an LCD (Liquid Crystal Display) or other related displaying interface.
